(19) United States
(12) Patent Application Publication
(10) Pub. No.: US 2007/0222201 A1
(43) Pub. Date: Sep. 27, 2007

(54) ROBOT TRAILER

(76) Inventor: TOM BRAITHWAITE, Ancaster (CA)

Correspondence Address: MARK A KOCH, 866 MAIN STREET EAST, HAMILTON, ON, L8M1L9, US

(21) Appl. No.: 11/688,297

(22) Filed: Mar. 20, 2007

Related U.S. Application Data
(60) Provisional application No. 60/767,419, filed on Mar. 27, 2006.

(51) Int. Cl. B62D 63/06

(52) U.S. Cl. 280/789

(57) ABSTRACT

A mobile trailer for use with a mobile robot, the trailer comprising a rollable frame for releasably attaching to a robot, a mechanism attached to the frame for selectively dispensing a communication cable, the cable providing communication between the trailer and command centre, a wireless communication mechanism for communicating wirelessly between the trailer and the robot, and a mechanism for selectively moving the trailer between a hitched position and unhitched, such that in the hitched position the trailer being pulled by the mobile robot, and in the unhitched position the trailer being detached from the mobile robot.

The application claims priority from previously filed U.S. provisional patent application No. 60/767,419, titled “ROBOT TRAILER” on Mar. 27, 2006 by Tom Braithwaite.

### FIELD OF THE INVENTION

The present invention relates to trailers which can be attached to robots and particularly this invention relates to a mobile robot trailer which can be hitched and unhitched from a mobile robot.

### SUMMARY OF THE INVENTION

The present invention is a mobile trailer for use with a mobile robot, the trailer includes a rollable frame for releasably attaching to a robot, a mechanism attached to the frame for selectively dispensing a communication cable, the cable providing communication between the trailer and command centre, a wireless communication mechanism for communicating wirelessly between the trailer and the robot, and a mechanism for selectively moving the trailer between a hitched position and unhitched, such that in the hitched position the trailer being pulled by the mobile robot, and in the unhitched position the trailer being detached from the mobile robot.

### BACKGROUND OF THE INVENTION

Mobile robots are currently used for numerous different purposes. For example mobile robots are used for bomb diffusing teams, wherein a mobile robot is sent into a building or into a location in order to diffuse a suspect package and/or explosive. The mobile robot is normally guided wirelessly from a command centre with a remote control unit and often will have to enter into confined spaces, metal buildings, concrete basements and/or other confined spaces. Normally, a number of video cameras are attached to the mobile robot in order to provide eyes for the person at the command centre which then sends wireless radio transmissions to the robot in order to guide and steer it on its proper course. The difficulty encountered in the field is loss of communication between the robot and the command centre due to thick layers of concrete, steel, rubble and other interferences with the radio signal which must travel from the mobile robot all the way back to the command centre. The command centre is usually positioned at a safe distance away form the suspected explosive in order to avoid injury to personnel should there be an unexpected explosion.

The loss of signal to the robot results in a failed attempt to diffuse the situation and therefore is highly undesirable. In order to provide for a more dependable signal between the robot and the command centre, the present invention contemplates the use of a mobile trailer which can be hitched and unhitched from the robot and provides for a hard wire communication cable which provides electronic communication between the trailer and the command centre and further provides a wireless communication mechanism between the trailer and the robot. By the use of such a mobile trailer, the loss of communication between the command centre and the robot is diminished, since the trailer can be moved into position much closer to the working area of the robot without endangering the command personnel.

### BRIEF DESCRIPTION OF THE DRAWINGS

The present invention will be described by way of example only with reference to the following drawings in which:

FIG. 1 is a side elevational schematic view of the present invention, a robot trailer shown in the hitched position deployed onto a robot shown in dashed lines.

FIG. 2 is a side elevational schematic view of the present invention, a robot trailer shown in the unhitched position together with a mobile robot shown in dashed lines.

FIG. 3 is a rear perspective schematic view of the present invention, a robot trailer deployed onto a robot and shown in the hitched position.

FIG. 4 is a side perspective schematic view of the present invention, a robot trailer together with a portion of the robot shown in dashed lines in the hitched position.

FIG. 5 is a front side perspective schematic view of the present invention, a robot trailer together with a portion of a robot shown in dashed lines in the unhitched position.

### DETAILED DESCRIPTION OF THE PREFERRED EMBODIMENT

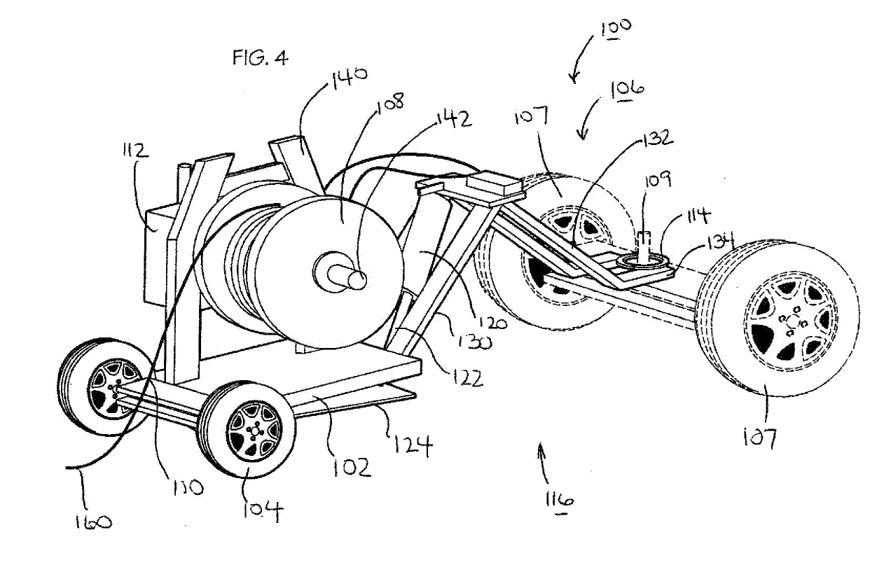

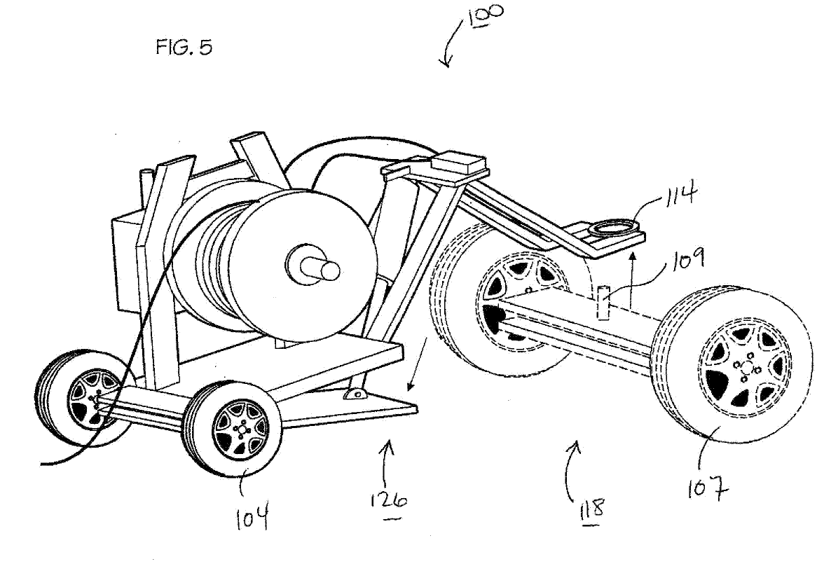

Referring now to FIG. 4 which is a side perspective view of the present invention, a robot trailer shown generally as 100 together with a portion of a mobile robot shown in dashed lines.

Robot trailer 100 includes the following major components, namely a frame 102 having wheels 104, a draw frame 106 including an attachment ring 114, a reel 108, having communication cable 110 taken up thereon and a transmitter 112.

In FIG. 4 robot trailer 100 is shown in the hitched position 116, whereas in FIG. 5, robot trailer 100 is shown in an unhitched position 118.

Robot trailer 100 further includes an actuator 120 having an actuator ram 122 attached to a lift pad 124.

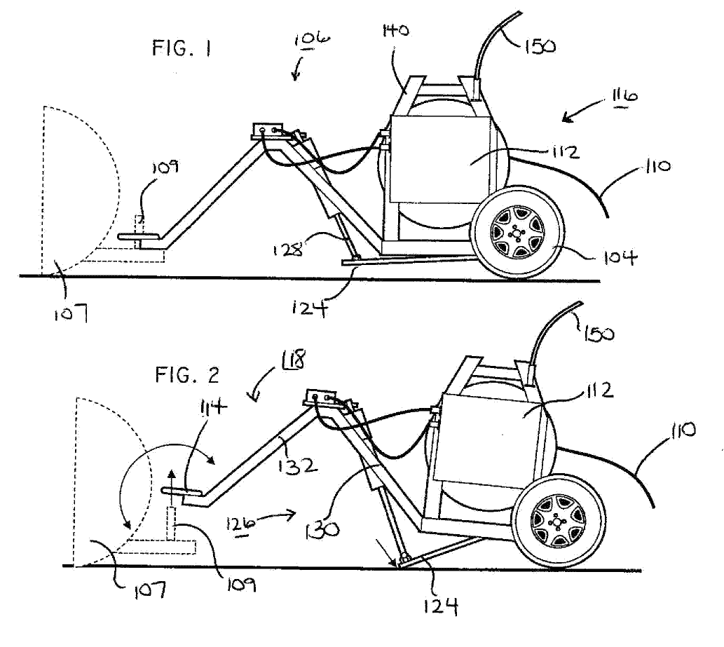

As best seen in FIGS. 1 and 2, lift pad 124 is shown in the down position 126 in FIG. 2 and is shown in the up position 128 in FIGS. 1.

Draw frame 106 preferably includes upwardly disposed draw members 130 rigidly attached to downwardly disposed draw members 132 which terminate at a draw bar 134 having a ring 114 rigidly attached thereto.

Reel 108 is attached to frame 102 with a reel bracket 140 which also has rigidly attached thereto a reel axle 142 and the transmitter 112. Reel 108 selectively dispenses communication cable 110 as robot trailer 100 is pulled along by mobile robot 103. One end of communication cable 110 is electrically connected with transmitter 112. Transmitter 112 order to provides a wireless signal and wireless communication between robot trailer 100 and robot 103. Robot trailer 100 includes an antenna 150 which can transmit and receive electronic signals from robot 103. Robot 103 would have a corresponding receiver for receiving electronic transmissions from transmitter 112 and also for sending signals from robot 103 back to transmitter 112. In other words, two way wireless communications is enabled between robot trailer 100 and robot 103.

End 160 of communication cable 110 is hardwired to a command centre not shown in the figures. The command centre will send communication signals, via communication cable 110 from the command centre to robot trailer 100. The communication signals travel along communication cable 110, thereby ensuring that there is no loss of communication between the command centre not shown and robot trailer 100.

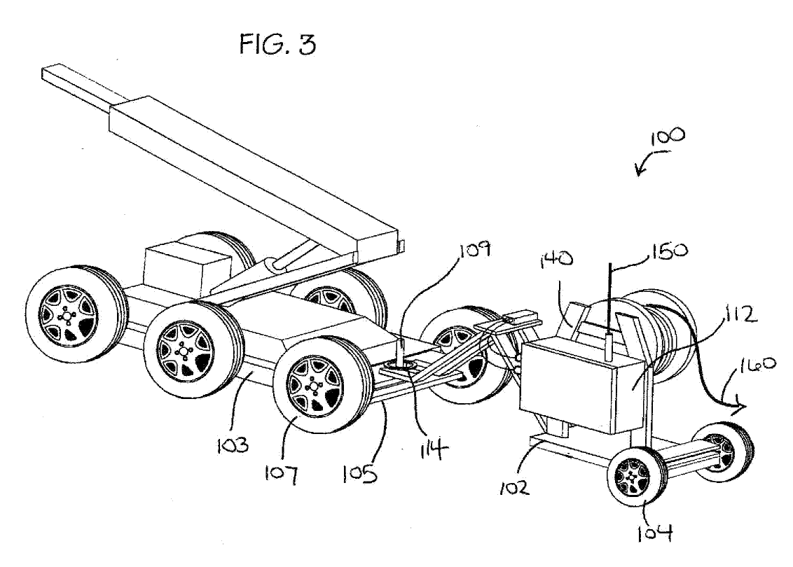

As shown in FIG. 3 a mobile robot 103 typically will include robot wheels 107, a robot frame 105 and in this case a robot pin 109 for receiving there over an attachment ring 114.

### In Use

In use robot trailer 100 can be placed in a hitched position as shown in FIG. 1, wherein attachment ring 114 is placed over robot pin 109. In this position as robot 103 moves forward under its own power, it will pull robot trailer 100 with it. Therefore, in hitched position 116, robot 103 and robot trailer 100 move forwardly in unison.

Reel 108 attached to robot trailer 100 dispenses communication cable 110 as required as robot trailer 100 moves forwardly together with robot 103. End 160 of communication cable 110 is hard wired to a command centre and the other end is connected to transmitter 112. Therefore, the command centre is communicating with a hardwire to robot trailer 100 and in turn, robot trailer 100 is communicating wirelessly with robot 103.

Communication cable 110 can include copper wire, fiber optic cable, and/or any other hardwired communication means which is capable of providing communication between the command centre and robot trailer 100. As mobile robot 103 is moved into position as for example in side a metal and/or concrete building, the command centre Will send a command to robot trailer 100 to move from the hitched position 116 to the unhitched position 118 as shown in FIG. 2 and also in FIG. 5.

Robot trailer 100 will communicate a signal to actuator 120 which will move actuator ram 122 downwardly thereby urging lift pad 124 onto the ground raising the draw bar 134 with its attachment ring 114 off of robot pin 109, thereby disconnecting robot trailer 100 from robot 103 and placing robot trailer 100 in the unhitched position 118. In the unhitched position 118, robot 103 is free to move independently of robot trailer 100 and communication between robot trailer 100 and robot 163 is carried out wirelessly between robot 103 and robot trailer 100. In this manner, the wireless signal between robot trailer 100 and robot 103 is shortened considerably and as a result, the possibility of losing wireless communication between robot 103 and the command centre is greatly diminished.

Robot 103 is free to move without the interference of having to pull robot trailer 100 along with it in order to carry out its assigned tasks and upon completion, robot 103 can be brought back into position, such that robot pin 109 is positioned under attachment ring 114 as shown in the unhitched position in FIG. 2 and thereafter a command signal can be sent to robot trailer 100 causing actuator 120 to retract actuator ram 122 thereby retracting lifting pad 124 into the up position 128 and placing robot trailer 100 back in the hitched position 116.

A person skilled in the art will recognize that a person in the command centre remains safely at a distance, and yet wireless communications between the robot and the command centre is essentially reduced by the length of communication cable 110 dispensed by reel 108 of robot trailer 100.

What is claimed is:

1. A mobile trailer for use with a mobile robot, the trailer comprising;
(a) a frame for releasably attaching to a robot, the frame adapted to be propelled by the robot;
(b) a cable means attached to the frame for selectively dispensing a communication cable, the cable providing communication between the trailer and a remotely located command center.

2. The mobile trailer claimed in claim 1 wherein the cable means including a reel adapted for dispensing communication cable as the trailer is propelled.

3. The mobile trailer claimed in claim 1 further including a hitch means receiving control signals for selectively moving the trailer between a hitched position and unhitched, such that in the hitched position the trailer being propelled by the mobile robot, and in the unhitched position the trailer being detached from the mobile robot.

4. The mobile trailer claimed in claim 3 wherein the hitch means includes an actuator adapted to lift the trailer thereby operably detaching the trailer from the mobile robot.

5. The mobile trailer claimed in claim 4 wherein the actuator being downwardly disposed and attached at one end to the frame and including an actuator ram emanating from the other end, the actuator ram including a lift pad attached to the distal end, such that the lift pad adapted to impinge on the ground and thereby lift the trailer operably detaching the trailer from the mobile robot.

6. The mobile trailer claimed in claim 3 wherein the control signals for the hitch means being communicated along the communication cable.

7. The mobile trailer claimed in claim 1 further including a wireless communication means for communicating wirelessly between the trailer and the robot.

8. The mobile trailer claimed in claim 1 wherein the frame including wheels for rollably being pulled behind the mobile robot.

9. A mobile trailer for use with a mobile robot, the trailer comprising:
(a) a frame for releasably attaching to a robot, the frame adapted to be propelled by the robot;
(b) a cable means attached to the frame for selectively dispensing a communication cable, the cable providing communication between the trailer and a remotely located command center,
(c) a wireless communication means for communicating wirelessly between the trailer and the robot,
(d) such that the trailer communicating via the communication cable to the remote command center and communicating wirelessly from the trailer to the mobile robot.

10. The trailer claimed in claim 9 further including a hitch means receiving control signals for selectively moving the trailer between a hitched position and unhitched, such that in the hitched position the trailer being propelled by the mobile robot, and in the unhitched position the trailer being detached from the mobile robot.

11. The trailer claimed in claim 9 wherein the trailer further including a ring rigidly attached to the frame for cooperating with an vertically oriented robot pin such that vertically lowering the ring over the pin places the trailer in an hitched position and vertically raising the ring off of the pin places the trailer in an unhitched position

12. The trailer claimed in claim 11 wherein the trailer further including a draw bar attached at one end to the ring and at the other end operably connected to the frame.

13. The trailer claimed in claim 12 wherein the trailer further including an upwardly disposed draw member attached at one end to the frame and at the other end to a downwardly disposed draw member, and the downwardly disposed draw member attached at the other end to the drawbar.

14. A mobile trailer for use with a mobile robot, the trailer comprising:
(a) a rollable frame for releasably attaching to a robot, the frame adapted to be propelled by the robot;
(b) a means attached to the frame for selectively dispensing a communication cable, the cable providing communication between the trailer and command centre;
(c) a wireless communication means for communicating wirelessly between the trailer and the robot; and
(d) a means for selectively moving the trailer between a hitched position and unhitched, such that in the hitched position the trailer being pulled by the mobile robot, and in the unhitched position the trailer being detached from the mobile robot.
